(19) United States
(12) Patent Application Publication
(10) Pub. No.: US 2018/0277811 A1
(43) Pub. Date: Sep. 27, 2018

(54) SEPARATOR OF LITHIUM ION BATTERY AND METHOD FOR MAKING THE SAME

(71) Applicant: Tsinghua University, Beijing (CN)

(72) Inventors: ZHEN LIU, Beijing (CN); YU-MING SHANG, Beijing (CN); XIANG-MING HE, Beijing (CN); LI WANG, Beijing (CN)

(73) Assignee: Tsinghua University, Beijing (CN)

(21) Appl. No.: 15/992,173

(22) Filed: May 30, 2018

Related U.S. Application Data
(63) Continuation of application No. PCT/CN2016/106247, filed on Nov. 17, 2016.

(30) Foreign Application Priority Data
Nov. 30, 2015 (CN) 201510852200.4

(51) Int. Cl. H01M 2/16; H01M 10/0525; H01M 4/62; H01M 4/36

(52) U.S. Cl. CPC H01M 2/16; H01M 4/366; H01M 4/623; H01M 10/0525

(57) ABSTRACT

A lithium ion battery separator comprises a separator substrate and two halloysite nanotube coatings, wherein the separator substrate has two opposite surfaces, and the two halloysite nanotube coatings are respectively disposed on the two opposite surfaces of the separator substrate. A method for making the lithium ion battery separator is further provided.

This application claims all benefits accruing under 35 U.S.C. § 119 from China Patent Application No. 201510852200.4, filed on Nov. 30, 2015 in the State Intellectual Property Office of China, the content of which is hereby incorporated by reference. This application is a continuation under 35 U.S.C. § 120 of international patent application PCT/CN2016/106247 filed on Nov. 17, 2016, the content of which is also hereby incorporated by reference.

### FIELD

The present disclosure relates to battery technology, and more particularly, to a separator of lithium ion battery and a method for making the same.

### BACKGROUND

With the growing energy problem and environmental pollution, new and cleaner energy has received increasing attention. The battery technology has made significant progress since the development of electrochemistry and the requirement to new energy-storage power source is being increased. Lithium ion batteries are widely used in portable electronics (such as laptops and phones) and have considerable potential in space technology, national defense and the like due to its high voltage, high energy density, long cycle life, and no memory effect.

The main components of the lithium ion battery include a cathode, an anode, a separator, and an electrolyte liquid. As one of the main components of the lithium ion battery, the separator is a significant factor in the safety performance and the electrochemical performance of the lithium ion battery. At present, a polyolefin microporous membrane, such as a polypropylene (PP) membrane, a polyethylene (PE) membrane, and a multi-layer composite membrane, is a commonly used separator due to its mechanical strength and chemical stability. However, the polyolefin microporous membrane shrinks easily at high temperature, has low porosity, and has a poor liquid conservation rate, which adversely affects the safety performance and the service life of the lithium ion battery. A plurality of heat-resisting inorganic nanoparticles, such as Al₂O₃, SiO₂, and TiO₂, can be coated on a surface of the separator to improve the dimensional stability and wettability of the separator. However, this method has a high production cost, non-uniform dispersion, and water absorbency of the inorganic nanoparticles.

### SUMMARY

A lithium ion battery separator and a method for making the same are provided.

An aspect of the present disclosure includes a lithium ion battery separator comprising a separator substrate and two halloysite nanotube coatings. The separator substrate has two opposite surfaces. The two halloysite nanotube coatings are respectively disposed on the two opposite surfaces.

The separator substrate is a porous structure with a plurality of micropores.

The two halloysite nanotube coatings are respectively coated on the two opposite surfaces.

The separator substrate is a polyolefin microporous membrane.

The halloysite nanotube coating comprises a plurality of halloysite nanotubes and a polymer binder. The plurality of halloysite nanotubes are uniformly mixed with the polymer binder to form a halloysite nanotube non-woven fabric coating.

The polymer binder is one or more of a polyurethane, a polyvinylidene fluoride, and a polyimide.

The method for making the lithium ion battery separator comprises the following steps:

S1, providing a halloysite nanotube raw material;

S2, providing a polymer binder and a solvent, and dispersing the halloysite nanotube raw material and the polymer binder in the solvent, thereby obtaining a coating slurry comprising a plurality of halloysite nanotubes and the polymer binder; and

S3, providing a separator substrate with two opposite surfaces, and coating the coating slurry on the two opposite surfaces respectively to form two halloysite nanotube non-woven fabric coatings.

In S1, the halloysite nanotube raw material can be a plurality of halloysite nanotubes modified with a silane coupling agent.

In S2, the solvent is one or more of tetrahydrofuran, chloroform, N,N-dimethylformamide, N,N-dimethylacetamide, and N-methylpyrrolidone.

In S2, the polymer binder is one of a polyurethane, a polyvinylidene fluoride, and a polyimide.

In an aspect of the present disclosure, the surfaces of the plurality of halloysite nanotubes are modified with the silane coupling agent, and the plurality of modified halloysite nanotubes are mixed with the polymer binder by using a solution co-mixing method to form the coating slurry for ceramifying the lithium ion battery separator, thereby improving the heat stability and the electrochemical performance of the lithium ion battery. The halloysite nanotubes (HNTs) are inexpensive natural nanotubes, which are 1:1 double-layered type aluminosilicate having a molecular formula of Al₂SiO₅(OH).nH₂O (n=0 or 2) and a typical crystal structure. The halloysite nanotubes generally are multiwall tubular structures which are rolled from an inner layer of aluminum-oxygen octahedron crystal lattice and an outer layer of silicon-oxygen tetrahedron crystal lattice between which crystal water exists. The inner and outer surfaces of the halloysite nanotubes have silicon hydroxyl and aluminium hydroxyl. The halloysite nanotubes have a special tubular structure with a length ranging from about 1 m to about 15 m and a diameter ranging from about 10 nm to about 15 nm. The plurality of halloysite nanotubes is composited with the polymer binder to obtain a polymer/inorganic nanotube composite material.

### BRIEF DESCRIPTION OF THE DRAWINGS

Implementations are described by way of example only with reference to the attached figures.

FIG. 1 is a schematic structure view of one embodiment of a lithium ion battery separator of the present disclosure.

FIG. 2 is an enlarged schematic structure view of a halloysite nanotube coating of the lithium ion battery separator shown in FIG. 1.

FIGS. 3A and 3B are scanning electron microscope images of a surface modified halloysite nanotube material of the lithium ion battery separator of the present disclosure.

FIG. 4 is a scanning electron microscope image of the halloysite nanotube coating comprised of the halloysite nanotube material.

FIG. 5 is a flow chart of one embodiment of a method for making the lithium ion battery separator of the present disclosure.

### DETAILED DESCRIPTION

A detailed description with the above drawings is made to further illustrate the present disclosure.

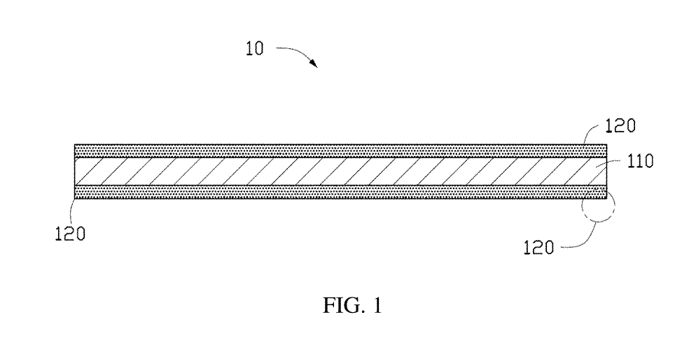

Referring to FIG. 1, one embodiment of a lithium ion battery separator 10 includes a separator substrate 110 and two halloysite nanotube coatings 120. The separator substrate 110 can be a flat structure, such as a membrane with a predetermined thickness. The separator substrate 110 can have two opposite surfaces. The two halloysite nanotube coatings 120 can be respectively disposed on the two opposite surfaces of the separator substrate 110.

The separator substrate 110 can be a polyolefin microporous membrane, such as a polypropylene (PP) membrane, a polyethylene (PE) membrane, or a multilayer composite membrane thereof. A plurality of micropores can be defined in the separator substrate 110. The two halloysite nanotube coatings 120 can be respectively coated on the two opposite surfaces of the porous membrane. In one embodiment, the separator substrate 110 is a polyethylene (PE) membrane with a thickness of 25 μm.

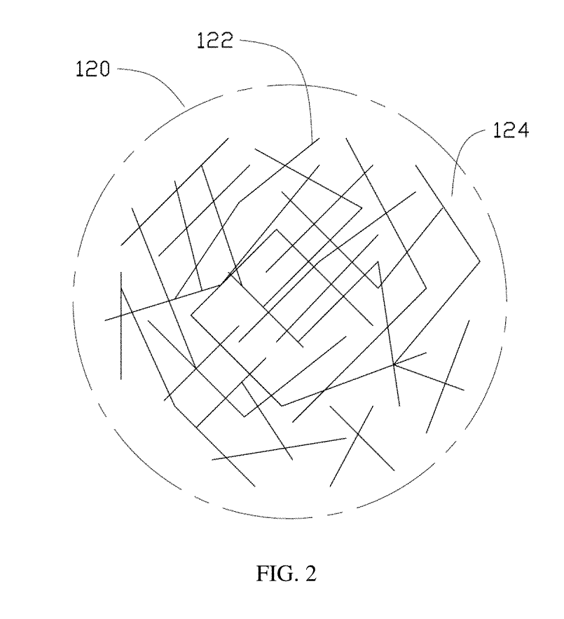

Referring to FIG. 2, the halloysite nanotube coating 120 can include a plurality of halloysite nanotubes 122 and a polymer binder 124. The plurality of halloysite nanotubes 122 and the polymer binder 124 can be composited together to form the halloysite nanotube coating 120. The material of the polymer binder 124 can be polyurethane, polyvinylidene fluoride, polyimide, or combinations thereof. In one embodiment, the material of the polymer binder 124 is polyimide.

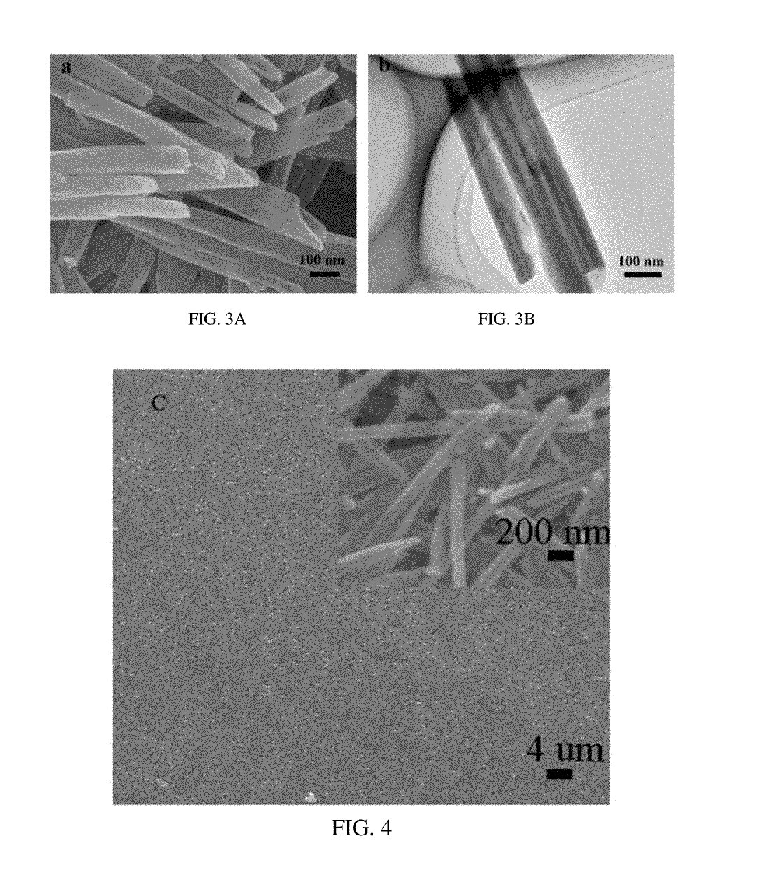

Referring to FIGS. 3A and 3B, the plurality of halloysite nanotubes 122 can be functional halloysite nanotubes. For example, surfaces of the plurality of halloysite nanotubes 122 can be modified by a silane coupling agent. The silane coupling agent can be grafted onto the surfaces of the plurality of halloysite nanotubes 122 by covalent bonds. After the surface modification of the halloysite nanotubes 122, the polymer binder 124 can be dispersed uniformly in the halloysite nanotube coating 120. Referring to FIG. 4, the plurality of halloysite nanotube 122 can be respectively dispersed on the two opposite surfaces of the separator substrate 110. It should be understood that the method of the functionalization of the plurality of halloysite nanotubes 122 is not limited to the surface modification, and can be any functionalization method that is beneficial for uniform dispersion of the plurality of halloysite nanotubes 122.

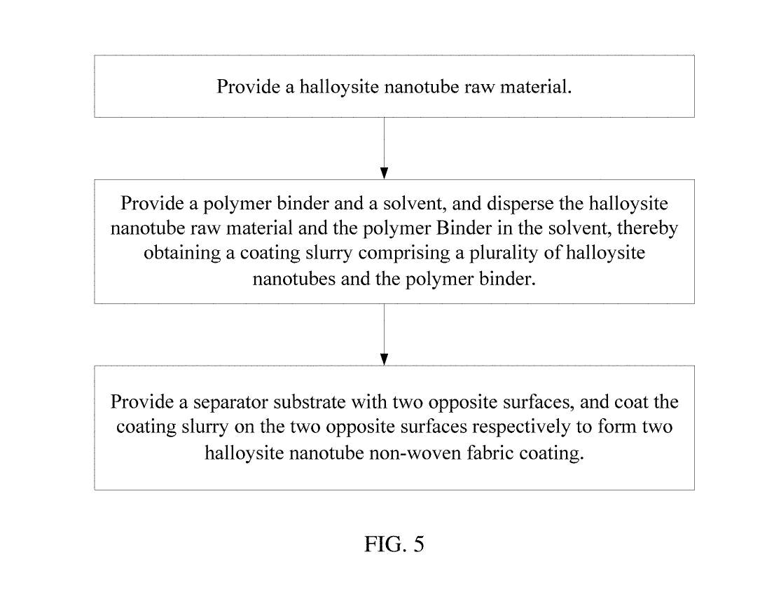

Referring to FIG. 5, one embodiment of a method for making the lithium ion battery separator 10 includes the following steps:

S1, providing a halloysite nanotube raw material;

S2, providing the polymer binder 124 and a solvent, and dispersing the halloysite nanotube raw material and the polymer binder 124 into the solvent, thereby obtaining the coating slurry including the plurality of halloysite nanotubes 122 and the polymer binder 124;

S3, providing the separator substrate 110 with the two opposite surfaces, and coating the coating slurry on the two opposite surfaces of the separator substrate 110 respectively to form the two halloysite nanotube coatings 120.

In S1, a surface functionalization can be applied to the halloysite nanotube raw material, which includes the following steps:

S1, purifying the halloysite nanotube raw material to obtain the plurality of halloysite nanotubes 122; and

S22, surface modifying the plurality of halloysite nanotubes 122.

In S11, in one embodiment, the halloysite nanotube raw material can be mixed with deionized water to obtain a mixture in which a mass percentage of the halloysite nanotube raw material can be about 10%. Sodium hexametaphosphate accounting for about 5 percent of the mass of the halloysite nanotube raw material can be added into the mixture, stirred for about 30 minutes at room temperature, and let stand for about 30 minutes, after which a halloysite aggregation and impurities can be deposited at a bottom of a bottle and removed by filtration. The plurality of halloysite nanotubes 122 in the upper liquid can be collected by centrifuging and dried at about 80° C. for about 24 hours. The plurality of purified halloysite nanotubes 122 is then grinded and sieved.

In S12, the plurality of purified halloysite nanotubes 122 obtained in S11 can be put into a three necked bottle equipped with a condenser, and a solvent can be added into the three necked bottle. After ultrasonic dispersion for about 30 minutes, an inert gas can be delivered into the system for about 30 minutes, the silane coupling agent can be added, and the mixture can be refluxed for about 8 hours to about 12 hours. After the reaction, a solid product can be separated from the obtained liquid suspension by centrifuging the suspension. The solid product can be washed and dried to obtain the plurality of halloysite nanotubes 122 surface modified with the silane coupling agent.

In S12, the solvent can be one or more of ethanol, acetone, toluene, xylene, n-hexane, cyclohexane, tetrahydrofuran, methylene chloride, chloroform, and N,N-dimethylformamide.

In S12, a power of an ultrasonic cleaner used in the ultrasonic dispersion process of the plurality of halloysite nanotubes 122 can range from about 80 Hz to about 100 Hz.

In S12, the inert gas can be one or more of nitrogen and argon with a high purity.

In S12, the silane coupling agent can have a molecular formula of CH₃(CH₂)ₙSiX₃, wherein n is 1 to 17, hydrolysable group X at the end of the silane coupling agent can be one of ethoxy, methoxy, chloro, methoxyethoxy, acetoxy, and etc. By dispersing the plurality of halloysite nanotubes 122 in the organic solvent, and surface modifying the plurality of halloysite nanotubes 122 with the silane coupling agent, the silane coupling agent can be grafted onto the surfaces of the plurality of halloysite nanotubes 122 through covalent bonds, and the silane coupling agent changes the surface property of the plurality of halloysite nanotubes 122, so as to solve the problem that the halloysite nanotubes 122 are easy to aggregate and difficult to be uniformly dispersed. In addition, the surface modification method is simple and reliable.

In S12, a rotating speed of the centrifugation for separating the halloysite nanotubes from the liquid suspension can be in a range from about 4000 r/min to about 12000 r/min.

In S2, the plurality of modified halloysite nanotubes 122 with a tube diameter ranging from about 15 nm to about 100 nm and a tube length ranged from hundreds of nanometers to several microns are added in the solvent and dispersed uniformly by ultrasonic agitating. Then the polymer binder 124 is added and stirred to be dissolved, thereby obtaining the halloysite nanotube coating slurry.

In S2, in the halloysite nanotube coating slurry, a mass ratio of the polymer binder 124 to the plurality of halloysite nanotubes 122 can be in a range from about 0.1 to about 0.4.

In S2, the solvent can be one or more of tetrahydrofuran, chloroform, N,N-dimethylformamide, N,N-dimethylacetamide, and N-methylpyrrolidone. In one embodiment, the solvent is N,N-dimethylformamide.

In S2, the polymer binder can be one or more of polyurethane, polyvinylidene fluoride, and polyimide. In one embodiment, the polymer binder is polyimide.

In S2, a power of the ultrasonic cleaner used in the ultrasonic dispersion of the plurality of modified halloysite nanotubes 122 can be in a range from about 80 Hz to about 100 Hz.

In S3, the separator substrate 110 can be one or more of the Celgard® series of polyolefin separators. In one embodiment, the separator substrate 110 is Celgard® 2325.

In S3, a thickness of the halloysite nanotube coating 120 can be in a range from about 3 μm to about 5 μm.

### Example 1

5 g of purified halloysite nanotubes are put into a three necked bottle equipped with a condenser, and 250 mL of ethanol is added. After ultrasonic dispersion for 30 minutes, an inert gas is delivered into the system for 30 minutes to remove the oxygen absorbed on the surfaces of the halloysite nanotubes, 2.5 mL of octadecyl triethoxy-silane coupling agent is added, the mixture is refluxed for 8 hours to 12 hours, and then the reaction is terminated. The liquid suspension obtained after the reaction is centrifuged to obtain a solid product separated from the liquid suspension. The solid product is then washed with ethanol or acetone, and dried to obtain the modified halloysite nanotubes.

1 g of the modified halloysite nanotubes and 10 mL of N,N-dimethyl-formamide are mixed and uniformly dispersed by ultrasonic agitating to obtain a liquid dispersion. 0.185 g of polyimide binder is added and dissolved in the liquid dispersion by stirring to obtain a coating slurry. The coating slurry is coated respectively on two sides of a microporous Celgard® 2325 separator with a thickness of 25 μm and a porosity larger than 35%. A total thickness of the two coatings is controlled in a range from 3 μm to 5 μm. The separator after the coating is dried at a temperature of 60° C. for 24 hours to obtain the separator having the halloysite nanotube composite coating, which is a halloysite nanotube non-woven fabric ceramified separator.

### Example 2

5 g of purified halloysite nanotubes are put into a three necked bottle equipped with a condenser, and 250 mL of ethanol is added. After ultrasonic dispersion for 30 minutes, an inert gas is delivered into the system for 30 minutes to remove the oxygen absorbed on the surfaces of the halloysite nanotubes, 2.5 mL of dodecyl triethoxy-silane coupling agent is added, the mixture is refluxed for 8 hours to 12 hours, and then the reaction is terminated. The liquid suspension obtained after the reaction is centrifuged to obtain a solid product separated from the liquid suspension. The solid product is then washed with ethanol or acetone, and dried to obtain the modified halloysite nanotubes.

1 g of the modified halloysite nanotubes and 10 mL of N,N-dimethyl-formamide are mixed and uniformly dispersed by ultrasonic agitating to obtain a liquid dispersion. 0.185 g of a polyimide binder is added and dissolved in the liquid dispersion by stirring to obtain a coating slurry. The coating slurry is coated respectively on two sides of a microporous Celgard® 2325 separator with a thickness of 25 μm and a porosity larger than 35%. A total thickness of the two coatings is controlled in a range from 3 μm to 5 μm. The separator after the coating is dried at a temperature of 60° C. for 24 hours to obtain the separator having the halloysite nanotube composite coating, which is a halloysite nanotube non-woven fabric ceramified separator.

The plurality of modified halloysite nanotubes are composited with the polymer binder to prepare the halloysite nanotube coating slurry, and the halloysite nanotube coating slurry is used to form the halloysite nanotube coating on the separator substrate, thereby obtaining the halloysite nanotube composite separator. Referring to FIG. 4, the scanning electron microscope image shows that the plurality of modified halloysite nanotubes are uniformly dispersed on the surface of the separator, and constrained by the polymer binder to form a nano-coating having a non-woven fabric structure, so that the thermal dimensional stability of the separator is improved. The thermal shrinkage of the separator is smaller than 5% after being heated at 150° C. for 1.5 hours showing that after the purification and surface modification to the natural halloysite nanotubes, the obtained halloysite nanotubes are not easy to aggregate and can be dispersed uniformly, and thus can be used to ceramify the separator to significantly increase the thermal stability of the separator. Since the natural halloysite nanotubes are inexpensive as they can be obtained from a wide variety of sources, and the halloysite nanotube composite separator made from the halloysite nanotubes has improved tenacity and thermal stability, the composite separator of the present disclosure has a broad application prospect in lithium ion battery.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A lithium ion battery separator comprising a separator substrate having two opposite surfaces, and a halloysite nanotube coating disposed on each of the two opposite surfaces.

2. The lithium ion battery separator of claim 2, wherein the separator substrate is a porous structure defining a plurality of micropores.

3. The lithium ion battery separator of claim 2, wherein the halloysite nanotube coating is coated on each of the two opposite surfaces of the separator substrate.

4. The lithium ion battery separator of claim 2, wherein the separator substrate is a polyolefin microporous membrane.

5. The lithium ion battery separator of claim 1, wherein the halloysite nanotube coating comprises a plurality of halloysite nanotubes uniformly mixed with a polymer binder.

6. The lithium ion battery separator of claim 5, wherein surfaces of the plurality of halloysite nanotubes are modified with a silane coupling agent.

7. The lithium ion battery separator of claim 6, wherein the silane coupling agent has a molecular formula of CH₃(CH₂)ₙSiX₃, n is 1 to 17, and X is an ethoxy group, a methoxy group, a chloro group, a methoxyethoxy group, or an acetoxy group.

8. The lithium ion battery separator of claim 5, wherein the polymer binder is a polyurethane, polyvinylidene fluoride, polyimide, or combinations thereof.

9. The lithium ion battery separator of claim 1, wherein a thickness of the halloysite nanotube coating is in a range from about 3 μm to about 5 μm.

10. The lithium ion battery separator of claim 1, wherein an average length of the plurality of halloysite nanotubes is in a range from about 1 μm to about 15 μm, and an average diameter of the plurality of halloysite nanotubes is in a range from about 15 nm to about 100 nm.

11. A method for making the lithium ion battery separator, comprising:
providing a halloysite nanotube raw material, a polymer binder, and a solvent;
dispersing the halloysite nanotube raw material and the polymer binder into the solvent, thereby obtaining a coating slurry comprising a plurality of halloysite nanotubes and the polymer binder; and
providing a separator substrate having two opposite surfaces, and coating the coating slurry on the two opposite surfaces respectively to form two halloysite nanotube coatings.

12. The method of claim 11, wherein the halloysite nanotube raw material is a plurality of silane coupling agent modified halloysite nanotubes.

13. The method of claim 12, wherein the silane coupling agent has a molecular formula of CH₃(CH₂)ₙSiX₃, n is 1 to 17, and X is an ethoxy group, a methoxy group, a chloro group, a methoxyethoxy group, an acetoxy group, or combinations thereof.

14. The method of claim 11, wherein the solvent is tetrahydrofuran, chloroform, N,N-dimethylformamide, N,N-dimethylacetamide, N-methylpyrrolidone, or combinations thereof.

15. The method of claim 11, wherein the polymer binder is a polyurethane, a polyvinylidene fluoride, a polyimide, or combinations thereof.

16. The method of claim 11, wherein the separator substrate is a polyolefin microporous membrane.

17. The method of claim 11, wherein in the coating slurry, a mass ratio of the polymer binder to the plurality of halloysite nanotubes is in a range from about 0.1 to about 0.4.
